(19) United States
(12) Patent Application Publication
(10) Pub. No.: US 2005/0158441 A1
(43) Pub. Date: Jul. 21, 2005

(54) Confection product containing urea

(76) Inventors: Steve Zibell, Blue Island, IL (US); Lonnette Alexander, Chicago, IL (US)

Correspondence Address: Bell, Boyd & Lloyd LLC, P.O. Box 1135, Chicago, IL, 60690-1135, US

(21) Appl. No.: 11/026,683

(22) Filed: Dec. 29, 2004

Related U.S. Application Data
(60) Provisional application No. 60/534,606, filed on Jan. 5, 2004.

(51) Int. Cl. A23G 3/00

(52) U.S. Cl. 426/573; 426/660

(57) ABSTRACT

Methods and confection products for the neutralization of dietary acids contained in foodstuffs or within the product themselves are provided. To this end, a gelatinous confection product comprising an acid neutralizing buffer such as carbamide is provided as well as methods of using same.

### BACKGROUND OF THE INVENTION

The present invention relates generally to confection products or candy. More specifically, the present invention relates to improved confection products which may potentially provide other dental health benefits.

It is well known that sugar in foods and confections can be harmful to the consumer's teeth. It is also well known that sugar is converted to acids which causes tooth decay. Therefore, foods and confections containing acids and sugars converted to acids cause tooth decay.

In the mammalian mouth, there is a balance or equilibrium between mineral transport into the tooth, otherwise known as remineralization or healing, and mineral transport out of the tooth via dissolved ions, otherwise known as demineralization or decay. This equilibrium between tooth minerals and dissolved ions can shift as a result of differences in the oral fluid environment around the tooth.

A normal tooth is protected by a thin but strong layer of dental enamel. The key component of tooth enamel coating is hydroxyapatite, Ca₁₀(PO₄)₆(OH)₂, which consists primarily of calcium and phosphate. FIG. 1 illustrates the effect of an acidic environment on the demineralization and remineralization equilibrium. As illustrated in FIG. 1, where there is a high concentration of acid or a low pH in the oral fluid environment of the mouth, hydrogen ions are transported down a concentration gradient into the tooth enamel via pores in the enamel. Because the phosphate ions and the hydroxide ions of hydroxyapatite easily react with the hydrogen ions to form dihydrogen phosphate H₂PO₄⁻ and water, respectively, the tooth enamel itself is very sensitive to changes in pH. When the pH of the tooth environment drops below a critical level of 5.5 to 5.7, the hydroxyapatite mineral of tooth enamel begins to dissolve into the oral fluids as calcium and phosphate ions, thereby shifting the equilibrium toward demineralization of the tooth enamel. When the pH is above 5.7 and near neutral pH, remineralization occurs when the calcium and phosphate ions in the oral environment are free to precipitate into the tooth enamel to re-form the hydroxyapatite complex.

When a shift in equilibrium from remineralization to demineralization occurs, an environment in the tooth enamel is created in which dental caries or tooth decay begins and progresses. Dental caries is the progressive loss of tooth mineral followed by bacterial invasion into the demineralized tooth. Except for the common cold, dental caries is the most prevalent human disorder. See, The Merck Manual, Sixteenth Edition, p. 2480.

The interaction of three factors is believed to result in dental caries: a susceptible tooth surface, the proper microflora, and a suitable substrate for the microflora. Although several acidogenic microorganisms that are present in the mouth can initiate carious lesions, Streptococcus mutans is believed to be the primary pathogen. See, The Merck Manual, supra. This strain of bacteria adheres well to the susceptible tooth surface, produces high acid levels, and thrives in an acidic environment. Tooth decay begins when Streptococcus mutans, which resides principally in the plaque that adhere to a tooth's surface, metabolizes the fermentable carbohydrates that are consumed by the host. During the metabolism of the fermentable carbohydrates by the bacteria, lactic acid and other organic acids are secreted as a by-product. These acids reduce the pH of the surrounding plaque/tooth environment.

Due to repeated acid attacks which result from the further metabolism of fermentable carbohydrates by the bacteria, sub-surface lesions expand. Plaque bacteria use the monosaccharide components of dietary sucrose, i.e. glucose and fructose, and the energy of the disaccharide bond of sucrose to assemble extracellular polysaccharides. These extracellular polysaccharides substantially increase the thickness of plaque and change the physical characteristics of its extracellular space from a liquid to a gel.

Thick gel-plaque allows the development of an acidic environment against the tooth's surface and prevents exposure of the area to any buffering or anti-microbial effects of salivary flow. If the lesions continue to expand to the point that the enamel surface breaks, a cavity is formed and the process is no longer reversible.

Even though many strides have been made to reduce dental caries and tooth decay, including fluoridation and other improvements in dental care, tooth decay continues to be a significant problem. This is especially true in the adult population in which 80% of the tooth decay occurs in 20% of the population. See Featherstone, An Updated Understanding of the Mechanism of Dental Decay and its Prevention, Nutrition Quarterly, Vol. 14, No. 1, 1990, pp. 5-11.

A number of different strategies have been identified to counteract the carious cycle of demineralization, bacterial growth and acid production. These methods include inhibiting lactic acid production, killing bacteria which inhibits acid production, and stimulating saliva which raises pH by removing lactic acid through the use of chewable confections.

Calcium-containing compositions such as calcium carbonate have recently been used in confection products. Calcium carbonate, however, is very water-insoluble. Therefore, even though calcium carbonate is added to a confection product base, it is not released in sufficient levels into the mouth of chewer to effectively enhance the remineralization of tooth enamel. International Patent Application No. PCT/US00/07410, which was filed on Mar. 21, 2000 and assigned to the Applicant, discloses a sugar-free confection product that includes a therapeutically effective amount of calcium carbonate and a food grade acid to remineralize tooth enamel. The food grade acids, when added to the calcium-containing base, convert the insoluble calcium carbonate to its more soluble salt form allowing the calcium to be released into the saliva in the chewer's mouth. Calcium and phosphate ions in the saliva precipitate out to replace the hydroxyapatite that was dissolved by the organic acids created during the metabolism of the fermentable carbohydrates to enhance remineralization and/or reduce demineralization of tooth enamel. Typically, however, this remineralization process only occurs at pH levels above the critical level (5.5 to 5.7). Therefore, if the saliva does not sufficiently raise the pH, significant remineralization will not occur. By balancing the hydrogen ion concentration in the oral fluid environment at the surface of the tooth and within the enamel of the tooth, the demineralization process of converting mineral to solution is reversed.

### SUMMARY OF THE INVENTION

The present invention provides a composition and method for the neutralization of acids in the oral fluid environment. Pursuant to the present invention, a confection product is provided which includes a therapeutically effective amount of an acid-neutralizing agent that improves neutralization of acids which are released from the confection product and from other consumed food.

Acids produced by bacterial metabolism of residual carbohydrates in the oral cavity and acids in foods consumed by the consumer increase the hydrogen ion concentration in the oral cavity. Demineralization of teeth occurs when plaque pH falls below 5.5 leading to carious-lesions. Effective treatment of caries or tooth decay requires balancing the hydrogen ion concentration at the surface of the tooth and within the enamel of the tooth. Neutralizing the pH in the oral cavity changes the biochemistry of the environment around the tooth and shifts the equilibrium away from demineralization toward remineralization of the hydroxyapatite of tooth enamel. Although buffers are naturally present in saliva, they are not present in sufficiently high concentrations to inhibit bacteria-driven swings in pH or swings in pH resulting from consumption of foods with high hydrogen ion concentrations.

In an embodiment of the present invention, a confection product is provided which includes a therapeutically effective amount of a component chosen from the group consisting of carbamide, urea, calcium lactate, sodium ascorbate, trisodium citrate, hydrogen carbonate, adipic acid or glycin. In a preferred embodiment, the acid neutralizing agent is carbamide. Carbamide released from the confection product into the oral fluids of the mouth raises the pH back into neutral range and, thereby, reverses the demineralization process. The enzymatic hydrolysis of carbamide to ammonia, a weak base, into the oral fluids is responsible for the neutralization of the acids and an elevation of pH in the oral fluids.

Carbamide is primarily broken down by the bacterial enzyme urease. Bacteria such as Streptococcus and Actinomyces contain the urease enzyme and are commonly found in the oral cavity and, specifically, in dental plaque. Under a wide optimal pH range, bacterial urease catalyzes the hydrolysis of urea to ammonia and carbamate. The carbamate then spontaneously hydrolyzes to form carbonic acid and a second molecule of ammonia. In an acidic environment, the ammonia molecules become protonated, resulting in a net increase in pH.

To this end, the present invention provides a confection product comprising a gelatinous confection product which includes a water-soluble gelatin portion, a sweetener, a flavor, and a sufficient amount of an acid-neutralizing agent to neutralize any acid generated in a mouth of a consumer due to the confection product.

In an embodiment of the present invention, the acid-neutralizing agent is selected from the group consisting of: carbamide, calcium lactate, sodium ascorbate, trisodium citrate, hydrogen carbonate, adipic acid and glycin.

In an embodiment of the present invention, the carbamide comprises approximately 0.05% to about 7.50% by weight of the confection product.

In an embodiment of the present invention, the carbamide comprises approximately 3.0% to about 3.5% by weight of the confection product.

In an embodiment of the present invention, the gelatinous confection product includes at least one additional oral health ingredient.

In an embodiment of the present invention, the sweetener is selected from the group consisting of: sorbitol, xylitol, maltitol, mannitol, hydrogenated starch hydrolysates, sucralose, aspartame, salts of acesulfame, alitame, saccharin and its salts, cyclamic acid and its salts, glycyrrhizin, dihydrochalcones, thaumatin, monellin, polydextrose, erythritol, and nutriose.

In an embodiment of the present invention, the sweetener is maltitol.

In an embodiment of the present invention, the present invention includes an amount of carbamide sufficient to neutralize at least a portion of additional acids occurring in a mouth of a consumer due to the consumption of said gelatinous confection product.

In a further embodiment of the present invention a method of neutralizing acids in the mouth of a consumer is provided. The method comprises the steps of providing a gelatinous confection product comprising carbamide and consuming the gelatinous confection product.

In an embodiment, the method includes chewing said product.

In a still further embodiment of the present invention, a method of minimizing the demineralization of teeth during the consumption of a gummy confection is provided. The method includes the steps of providing a gelatinous gummy confection product comprising carbamide and consuming the gelatinous confection product.

In an embodiment of the present invention, the method includes consuming at least two pieces of confection product at a time.

In an embodiment of the present invention, the method includes consuming the confection product after consuming foodstuffs containing acids.

In an embodiment of the present invention, the method includes consuming the confection product after consuming foodstuffs containing sugar.

An advantage of the present invention is to provide a method for preventing or reducing the risk of dental caries.

Another advantage of the present invention is to provide a method of preventing the demineralization of tooth enamel.

A still further advantage of the present invention is to treat dental caries.

Additionally, an advantage of the present invention is to provide a confection product that can be used to improve dental health.

Further, an advantage of the present invention is to provide a confection product that improves the acid-neutralizing effect of saliva.

Moreover, an advantage of the present invention is to provide an easy and enjoyable way to improve dental health.

A further advantage of the present invention is that it provides a confection product having low-cost dental health benefits.

Additional features and advantages of the present invention are described in, and will be apparent from, the detailed description of the presently preferred embodiments and the drawings.

### BRIEF DESCRIPTION OF THE FIGURES

FIG. 1 illustrates the effect of an acidic environment on the balance between demineralization and remineralization.

FIG. 2 illustrates the acid-neutralizing effect of carbamide on the balance between demineralization and remineralization.

FIGS. 3A to 3D graphically illustrate changes in pH over time in response to consumption of the confection product with and without carbamide followed by a sucrose challenge.

FIGS. 4A to 4F graphically illustrate changes in pH over time in response to a sucrose challenge followed by consumption of the confection product with and without carbamide.

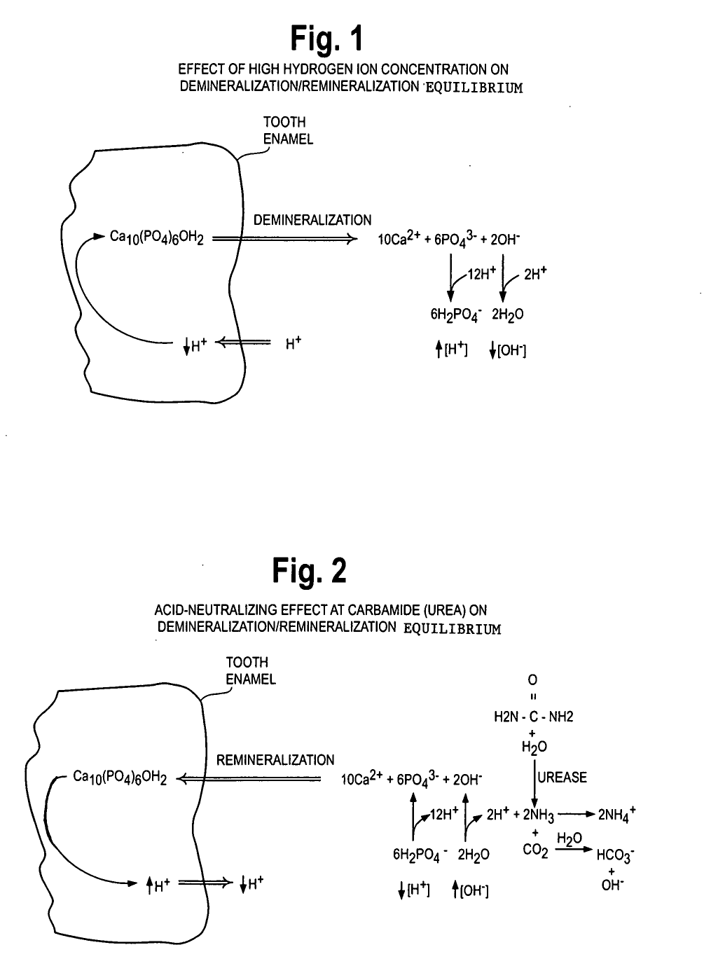

### DETAILED DESCRIPTION OF THE INVENTION

The present invention provides methods and compositions for reversing the demineralization of tooth enamel. Thus, the present invention provides methods and compositions for preventing and/or treating dental caries. Pursuant to the present invention, a confection product is provided that includes a therapeutically effective amount of an acid-neutralizing additive such as carbamide or urea. Thus, the confection product of the present invention may even improve dental health when consumed or chewed.

In an embodiment of the present invention, a confection product is provided which includes a therapeutically effective amount of carbamide or urea as an acid-neutralizing agent. Carbamide is a water-soluble by-product of the metabolism of nitrogen containing substances such as proteins present in fluids throughout the body and is also secreted into the oral cavity by the salivary glands. The carbamide contained in saliva, however, is not present in concentrations sufficient to buffer the elevated hydrogen ion concentrations caused by the organic acids produced by bacterial metabolism of residual carbohydrates in the oral cavity and the acids in foodstuffs. By supplementing a confection product with an effective amount of carbamide, the cumulative effect of the release of carbamide from the confection product and the stimulation of the flow of carbamide-containing saliva results in a neutralization of the acidic environment of the oral cavity and a reversal in the demineralization of the hydroxyapatite of tooth enamel.

It has specifically been found that carbamide added to a chewable gelatinous confection product such as a gummy will be hydrolyzed into ammonia and carbon dioxide by the action of a bacterial enzyme present in saliva known as urease. The bacteria responsible for producing urease is found in the natural microflora and, specifically, in dental plaque of the mammalian mouth. The breakdown of the carbamide into ammonia allows the neutralization of the acidic environment to occur immediate to the affected areas. Furthermore, because carbamide is able to permeate the outer layers of plaque almost immediately upon introduction to the mouth, the acidic environment protected by gel-thick plaque can be treated.

Although ammonia is a weak base, it reacts with water to produce ammonium ions and hydroxide ions.
NH₃(aq)+H₂O (l)⇄NH₄⁺(aq)+OH⁻(aq)
Carbon dioxide also binds the dissociated hydrogen ions to form bicarbonate ions leaving hydroxide ions. The overall reaction is as follows:

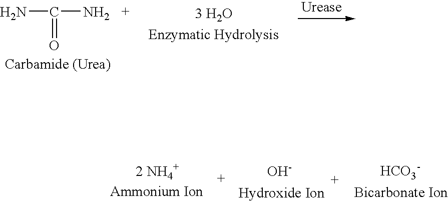

The increase in concentration of hydroxide ions [OH⁻] contributes to neutralizing the acidic environment created by sugar, acid-containing foods, or the acid released when chewing the confection product itself. Thus, when the confection product containing the carbamide is consumed or chewed, thereby releasing the carbamide into the oral cavity, the pH is returned to a neutral level, and demineralization is reduced in the mouth of the chewer.

The confection product composition may be any confection product formula. Such formulas typically contain a major amount of a sugar alcohol bulking agent, a substantial portion of base, minor amounts of syrups, high intensity sweeteners, flavoring agents, softeners, emulsifiers, colors, acidulants, fillers, antioxidants, and other components that provide desired attributes. Low calorie confection products which contain reduced levels of sugar alcohols and increased levels of base and/or low calorie or calorie-free bulking agents are also contemplated. The confection product may be formed into any variety of shapes, such as tabs, sticks, chunks, or pellets. The confection product may be formed into any suitable size, preferably weighing approximately one to about five grams and, more preferably, about two grams per piece. The confection product may include any number of flavors and may contain sugar or be sugarless. A preferred confection product is a gummy candy that comprises a gelatin portion.

In an embodiment, the confection product of the present invention contains sweeteners such as maltitol syrup which can constitute approximately 0% to about 50% by weight of the confection product and preferably comprises about 30% to 50% by weight of the product. The confection product can also include bulk sweeteners such as polydextrose in a quantity of 0 to about 50% by weight of the product and, preferably, about 10% to 20% by weight of the confection product. Gelatin can be present in a quantity of about 0.05% to about 20% by weight of the confection product, and, preferably, about 4% to about 15% by weight of the confection product. Other sweeteners may include xylitol in a quantity of 0% to about 50% by weight of the product and preferably about 1% by weight of the product. Other ingredients are present in minor amounts (about two percent or less) such as colorants, antioxidants, etc.

In an embodiment, the acid-neutralizing agent includes carbamide which comprises approximately 0.5% to about 7.5% by weight of the confection product, and preferably approximately 3.0% to about 3.5%. Sufficient levels of carbamide should be present in the confection product to restore the pH of the oral fluids or plaque pH within ten minutes of the release of the urea from the confection product, and preferably within five minutes of the confection product being introduced to the oral cavity.

The present invention may include sweeteners such as sugar, corn syrup, polyols, or sugarless sweeteners. The polyols or sugar alcohols can include, but are not limited to sorbitol, xylitol, maltitol, mannitol, hydrogenated starch hydrolysates, and the like, alone or in combination. In addition to being used as sweeteners, polyols can also be used as bulking agents which can provide some cooling properties. Bulk sweeteners or bulking agents include polydextrose, erythritol, Nutriose and the like.

Gelatin is used as the jelling agent which can be derived from pork, beef or fish. The gelatin can be between about 100 to about 300 bloom as desired, i.e. the higher the bloom, the more stiff the confection product becomes when it sets. The gelatin can be present in about 0.5% to 20% by weight of the product and preferably about 10% by weight of the product.

High intensity artificial sweeteners can also be used, alone or in combination, with the above. Preferred sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. Combinations of sugar and/or sugarless sweeteners may be used in the confection product.

Acids are used to enhance flavor, tartness and increase salivation. Acids used in the present invention may include citric acid, maelic acid, adipic acid, fumaric acid, tartaric acid and the like.

A variety of flavoring agents can be used. The flavor can be used in amounts of approximately 0.01 to about 1 weight percent of the confection product, and preferably, 0.04% to about 0.6%. Flavoring agents may include essential oils, synthetic flavors or mixtures thereof including, but not limited to, oils derived from plants and fruits such as citrus oils, fruit essences, peppermint oil, spearmint oil, clove oil, oil of wintergreen, and other mint oils, anise, vanilla, fruit flavors, savory flavors, tropical flavors, spicy flavors, floral and herbal flavors, cinnamon, cocoa, carmel, honey and the like. Artificial flavoring agents and components may also be used. Natural and artificial flavoring agents may be combined in any sensorially acceptable fashion.

Colorants and whiteners may include FD&C-type dyes and lakes, fruit juice concentrates, fruit and vegetable extracts, titanium dioxide, and combinations thereof.

Oils are used in the present invention as an anti-sticking agent to remove residue remaining on the confection product from the molds and to give the confection product a shiny appearance. The types of oils used can include blends of triglycerides, vegetable oils, coconut oil, soy-bean oil, sesame oil, palm kernel oil and the like.

The preferred buffering or acid-neutralizing agent includes carbamide, otherwise known as urea. It should be appreciated that other buffering agents used to stabilize the confection product, such as calcium lactate, sodium ascorbate, trisodium citrate, hydrogen carbonate, adipic acid or glycin, can be used instead of or in addition to the carbamide to actively neutralize the acid(s) in the confection product.

Additional oral health ingredients may be added including, but not limited to, other pH control agents (such as buffers), other inorganic components for tartar or caries control (phosphates, fluorides), and anti-plaque/anti-gingivitis agents (including chlorhexidene, CPC, triclosan). Any additional ingredients must be safe and effective and not react undesirably with the carbamide of the confection product.

By way of example and not limitation, the following examples illustrate various embodiments of the syrup and gummy product formulations of the present invention:

### EXAMPLES

| Syrups | Ex. C | Ex. D | Ex. E | Ex. F | Ex. G | Ex. H |
|---|---|---|---|---|---|---|
| Maltitol Syrup | 38.43 | 33.56 | 37.56 | 44.12 | 38.43 | 38.43 |
| Water | 16.47 | 16.33 | 16.33 | 15.33 | 16.47 | 16.47 |
| Polydextrose | 13.14 | 12.13 | 12.13 | 14.43 | 13.14 | 13.14 |
| Polyol | 1.99 | 0.78 | 0.78 | 0.73 | 2.73 | 1.99 |
| Ace-K | 0.14 | 0.02 | 0.04 | 0.02 | 0.14 | 0.14 |
| Water | 16.47 | 16.33 | 16.33 | 15.33 | 16.47 | 16.47 |
| Gelatin | 8.59 | 11.42 | 14.32 | 4.32 | 8.59 | 7.59 |
| Titanium | 0.05 | 0.07 | 0.23 | 0.23 | 0.05 | 0.05 |
| Dioxide | | | | | | |
| Urea | 2.49 | 7.50 | 0.05 | 4.03 | 1.75 | 3.50 |
| Citric Acid | 1.11 | 1.08 | 1.08 | 1.08 | 1.11 | 1.11 |
| Flavor | 0.42 | 0.52 | 0.52 | 0.04 | 0.42 | 0.42 |
| Maelic Acid | 0.31 | 0.23 | 0.53 | 0.32 | 0.31 | 0.31 |
| Aspartame | 0.29 | 0.03 | 0.10 | 0.02 | 0.29 | 0.28 |
| Calcium | 0.10 | 0.00 | 0.00 | 0.00 | 0.10 | 0.10 |
| Lactate | | | | | | |
| (6.6 g % soln) | | | | | | |
| Total | 100 | 100 | 100 | 100 | 100 | 100 |

| Gummies | Ex. I | Ex. J | Ex. K | Ex. L | Ex. M | Ex. N |
|---|---|---|---|---|---|---|
| Maltitol Syrup | 47.10 | 41.19 | 43.56 | 49.12 | 45.43 | 46.43 |
| Polydextrose | 16.02 | 12.13 | 12.13 | 14.43 | 16.14 | 13.14 |
| Polyol | 1.93 | 0.78 | 0.78 | 0.73 | 2.73 | 1.99 |
| Ace-K | 0.04 | 0.02 | 0.04 | 0.02 | 0.14 | 0.14 |
| Color | 0.03 | 0.03 | 0.03 | 0.03 | 0.03 | 0.03 |
| Gelatin | 9.02 | 11.42 | 14.82 | 7.95 | 10.59 | 12.59 |
| Titanium | 0.05 | 0.07 | 0.23 | 0.23 | 0.05 | 0.93 |
| Dioxide | | | | | | |
| Urea | 3.41 | 7.50 | 0.05 | 4.03 | 2.68 | 3.55 |
| Water | 19.97 | 25.00 | 20.50 | 22.00 | 19.98 | 18.98 |
| Citric Acid | 1.22 | 1.08 | 1.08 | 1.08 | 1.11 | 1.11 |
| Flavor | 0.55 | 0.52 | 0.12 | 0.04 | 0.42 | 0.42 |
| Maelic Acid | 0.36 | 0.23 | 0.23 | 0.32 | 0.31 | 0.31 |
| Aspartame | 0.29 | 0.03 | 0.10 | 0.02 | 0.29 | 0.28 |
| Calcium | 0.01 | 0.00 | 6.33 | 0.00 | 0.10 | 0.10 |
| Lactate | | | | | | |
| (6.6 g % soln) | | | | | | |
| Total | 100 | 100 | 100 | 100 | 100 | 100 |

The confection product can be prepared by any process or method known in the art. In one embodiment of the present invention, the preparation of the confection product includes hydrating the gelatin at a temperature preferably below 90° C. and, more preferably, at a temperature of about 70° C.. The sweetener(s) such as sugar, corn syrup or the polyol is cooked to a temperature of about 120° C.. Once the sweetener has been cooked to a temperature of about 120° C., it is removed from the heat and allowed to cool. When the sweetener has cooled to a temperature of about 90° C., the gelatin solution is slowly stirred into the sweetener mixture. Other ingredients, such as the flavors, colors and the buffering agents are then added to produce a mixture which is about 25% moisture.

At this point, the mixture is deposited into molds including starch, rubber or plastic molds. In one embodiment, starch molds are used to shape the confection product. The molds are made from starch containing a suitable amount of fat such that the moisture of the mold is less than 6% and, preferably, approximately 1-2%. Impressions are made in the starch molds, and the liquid solution is deposited into the starch mold. The confection product is allowed to set in the starch mold for a time period sufficient to allow the free water to be removed from the confection product and absorbed into the starch. At room temperature and a relative humidity at about 30 to 40%, the mixture may require at least 24 hours to set. It should be appreciated, however, that changing temperature and humidity may slow or accelerate the setting process.

After the confection product has set and the free water of the product has been absorbed in the starch, the confection product is removed from the starch mold. In one embodiment, the confection product is oiled to remove any excess starch and to give the confection a shiny appearance. In addition, the oil acts as an anti-sticking agent. If a plastic or rubber mold is used, oiling may not be necessary.

By way of example and not limitation, experiments demonstrating some advantages of the present invention will now be given.

The objectives of the experimentation were to determine if consuming one, three and five gummies containing carbamide is “safe for teeth” and if they neutralize plaque acids after a sugar challenge. The objectives also included determining if an acid-neutralizing agent could improve neutralization of acids both from the product itself and from a sucrose challenge after consumption of one, three and five gummies containing urea.

Measurements of plaque pH were performed according to standard telemetric methodology protocol as described in Monographs in Oral Science publication, “Identification of Low Caries Risk Dietary Components” (Vol. 11, Karger 1983) which is hereby incorporated herein by reference. As discussed above, it is well known that a strong causal correlation exists between the fall in plaque pH and caries activity. Certain food items are able to cause low pH values in dental plaque through the presence of acids in the food itself or through glycolytic acid formation. The term “safe for teeth” as used herein refers to consumables which have a low risk of promoting caries due to intraoral plaque pH telemetry readings showing no depression of the pH of interdental plaque below a pH of 5.7 either during consumption or up to 30 minutes later.

Intraoral plaque pH telemetry includes telemetry prostheses and a measurement recording system. The telemetry prostheses include electrometric cells comprising miniature glass pH and reference electrodes built into a prosthetic device. The electrodes of the prostheses are removably placed along the mandible to align the electrodes at the interdental spaces at the level of the enamel surface to measure plaque pH and in the oral cavity under the tongue to measure oral fluid pH. The telemetry prostheses are capable of providing continuous potentiometric measurements of plaque and oral fluid pH over a period of several hours conveying pH data to the recording system by means of wire connections.

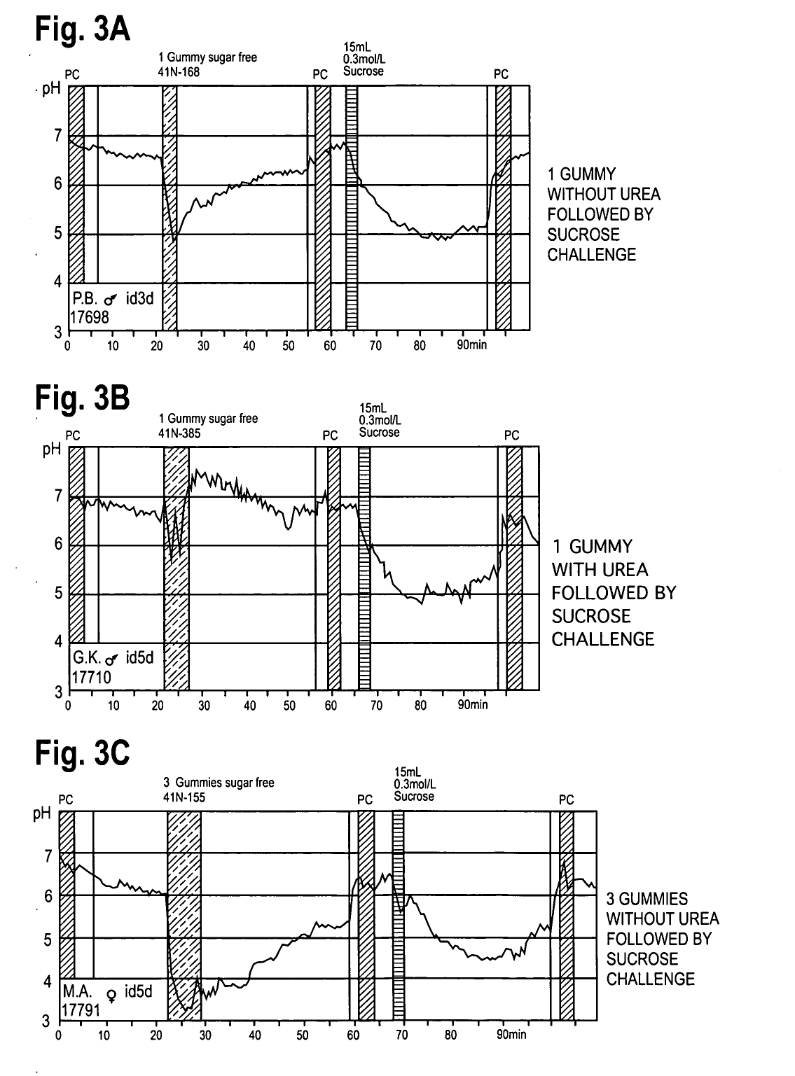

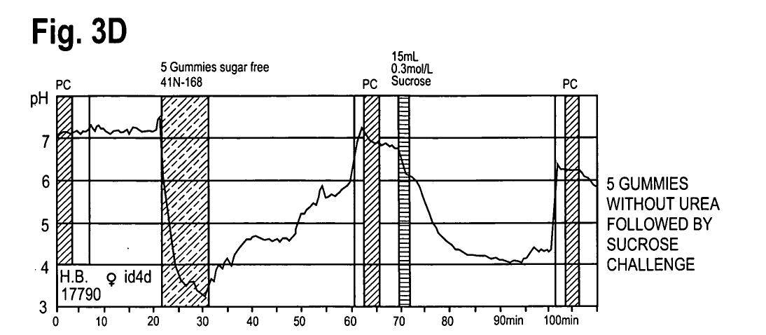

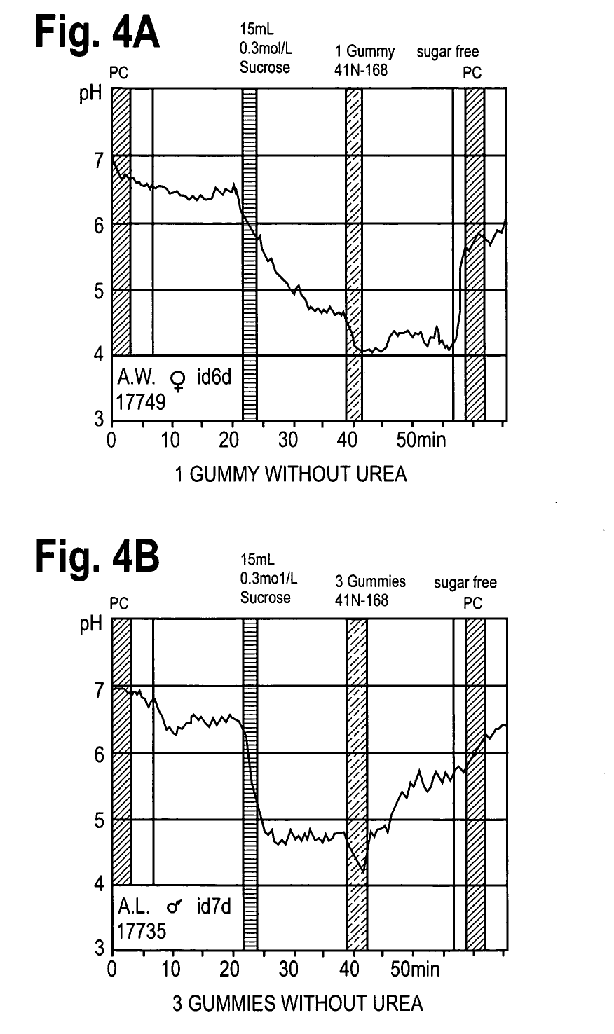

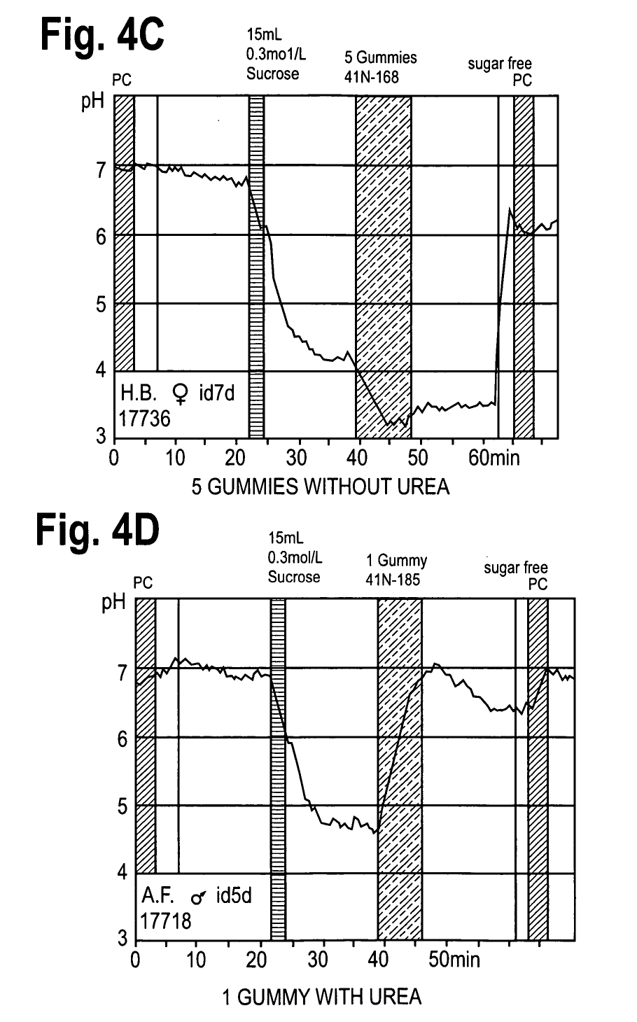

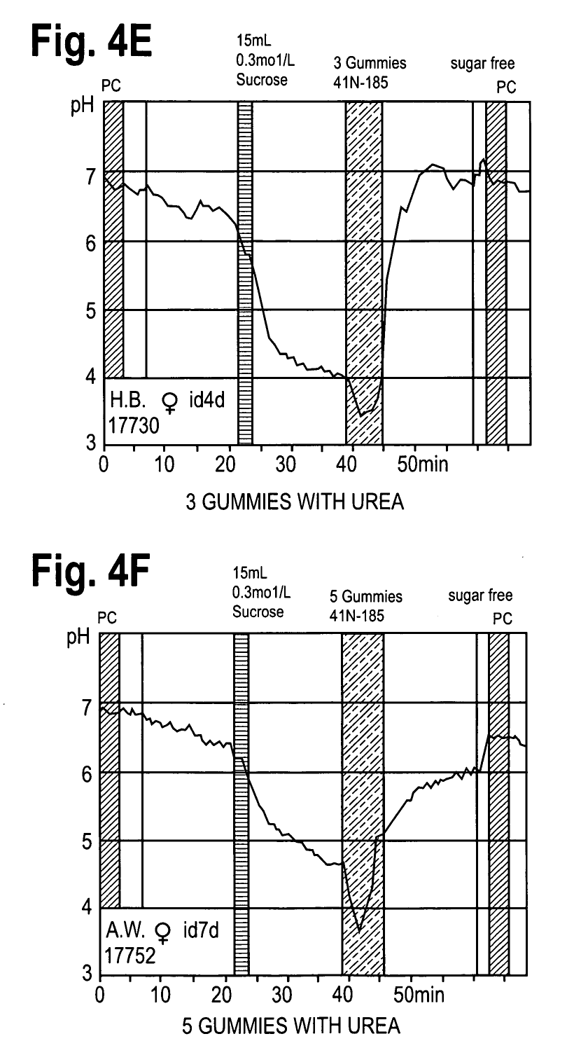

Referring to FIGS. 3 and 4, the samples tested include confection products with and without carbamide present in the amount of 3.5% by weight as represented by the formulations of Example I, and Example N above. The gummy confection products were two grams per piece and contained acids in the amount of about two percent by weight. Experimental subjects consumed one, three or five pieces of the confection products during a specific time period to determine if increased consumption and saliva stimulation counteract the acid.

The experiments included two subjects per sample with an additional two subjects per sample used if data was positive to provide some statistical significance of positive test results. The study was a double-blinded study where neither the technician nor the subjects knew which sample was being provided to the subject. Before readings were made, the electrodes were reset to a neutral pH by dropping on the electrodes two one-ml doses of normal buffer solution. In addition, before, between and after each introduction of sample or two-minute rinse with 15 ml of 0.3 mol/l sucrose solution, the subjects chewed neutral paraffin for approximately 3 minutes (PC). The paraffin chewing aided in quickly restoring plaque pH to normal through increased salivary flow. The sample(s) were eaten in a normal manner until the sample was swallowed and had disappeared from the oral cavity. Data was continuously accumulated throughout the chewing of the sample through at least twenty minutes after the sample had been consumed.

As illustrated in FIG. 3, the results of consuming one (FIG. 3A), three (FIG. 3C) and five (FIG. 3D) sugar-free gummy samples containing no carbamide with no sucrose challenge prior to consumption demonstrated that acid in the confection product lowered plaque pH below the safe level of a pH of 5.5. As illustrated in FIG. 3A, the data from these experiments demonstrate that consumption of a single two-gram piece of confection containing an acid level of as little as two percent without carbamide is not safe for teeth. The pH is believed to decrease as a result of the acid in the gummy sample and is not neutralized by the stimulated saliva. The pH levels also drop below a safe pH level of 5.5 when three or five individual gummies are eaten, as illustrated in FIG. 3C and FIG. 3D, respectively. This data suggests that increased acid release from three and five gummies is not effectively neutralized by what is likely only an incremental increase in saliva flow rate. The pH remained below the safe level during consumption. Plaque pH did increase after consumption in normal fashion, but the confection product without carbamide did not qualify as safe for teeth. The sucrose challenge following consumption of the gummy samples illustrate similar readings in decreasing pH over time after each sample consumption and paraffin chew.

FIG. 4 illustrates the results of consuming one, (FIG. 4A) three (FIG. 4B) and five (FIG. 4C) gummy samples without carbamide following a sucrose challenge compared with the results of consuming one, (FIG. 4D) three (FIG. 4E) and five (FIG. 4F) gummy samples with carbamide followed by a sucrose challenge. The sucrose challenges induced a depression in pH to below a safe level illustrating that, under natural conditions, there is no immediate spontaneous neutralization of interdental plaque acidified by fermentation of carbohydrates. The sucrose challenge also suggests that pH depression after the intake of the gummy sample has to be attributed to dietary acids contained in the gummy sample itself.

After fifteen minutes following the sucrose rinse, the gummy sample(s) was/were given to the subject with no intervening paraffin chew. The samples without carbamide remained below the safe pH level for the duration of the measurement. In contrast, the samples containing carbamide showed an initial acidification of the oral fluids by the release of the acids in the gummy sample(s) themselves followed by a relatively dramatic increase in the pH during consumption of the confection product. This data suggests that the two percent by weight acid content of the gummy samples themselves will not generate an erosion or demineralizing environment in the presence of acid-neutralizing carbamide. The pH reached a safe level above 5.5 during the consumption or within minutes of completing consumption of the carbamide-containing gummy samples. Moreover, pH levels remained at or above the safe level for the remaining duration of measurement—twenty minutes. The confection product containing 3.5% by weight carbamide, therefore, is considered to be safe for teeth.

Buffering additives such as carbamide provide a delayed but sustained neutralizing effect. The delay of the buffering action of carbamide is due to a faster release of water soluble acid from the gummy than the buffering action of the carbamide. Additional time is required for the carbamide to be split by salivary enzymes to form the acid-neutralizing ammonia and CO₂ as illustrated above. Unlike the acid which is released and swallowed or otherwise cleared from the oral cavity within a few minutes of chewing, the ammonia from the carbamide is somewhat bioadhesive and remains in the oral mucosa and in plaque for an extended acid-neutralizing effect. Furthermore, the enzymes (specifically, urease) required to hydrolyze carbamide are present in the plaque itself, causing the ammonia to be released directly in the area where it is needed and where the acid is measured.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A gelatinous confection product comprising:
a water-soluble gelatin portion;
a sweetener;
a flavor; and
a sufficient amount of an acid-neutralizing agent to neutralize any acid generated in a mouth of a consumer due to the confection product.

2. The gelatinous confection product of claim 1, wherein the acid-neutralizing agent is selected from the group consisting of: carbamide, calcium lactate, sodium ascorbate, trisodium citrate, hydrogen carbonate, adipic acid and glycin.

3. The gelatinous confection product of claim 2, wherein the carbamide comprises approximately 0.05% to about 7.50% by weight of the confection product.

4. The gelatinous confection product of claim 2, wherein the carbamide comprises approximately 3.0% to about 3.5% by weight of the confection product.

5. The gelatinous confection product of claim 1, which includes at least one additional oral health ingredient.

6. The gelatinous confection product of claim 1, wherein the sweetener is selected from the group consisting of: sorbitol, xylitol, maltitol, mannitol, hydrogenated starch hydrolysates, sucralose, aspartame, salts of acesulfame, alitame, saccharin and its salts, cyclamic acid and its salts, glycyrrhizin, dihydrochalcones, thaumatin, monellin, polydextrose, erythritol, and nutriose.

7. The gelatinous confection product of claim 1, wherein the sweetener is maltitol.

8. A gelatinous confection product comprising:
a water-soluble gelatin portion;
a sweetener;
a flavor; and
an amount of carbamide sufficient to neutralize at least a portion of additional acids occurring in a mouth of a consumer due to the consumption of said gelatinous confection product.

9. The gelatinous confection product of claim 8, wherein the carbamide comprises approximately 0.05% to about 7.50% by weight of the confection product.

10. The gelatinous confection product of claim 8, wherein the carbamide comprises approximately 3.0% to about 3.5% by weight of the confection product.

11. The gelatinous confection product of claim 8, which includes at least one additional oral health ingredient.

12. A confection product comprising:
a gelatin portion; and
approximately 0.05% to about 7.50% by weight carbamide.

13. The confection product of claim 12, which includes a sweetener and a flavor.

14. A method of neutralizing acids in the mouth of a consumer comprising the steps of:
providing a gelatinous confection product comprising carbamide; and
consuming the gelatinous confection product.

15. The method of claim 14, wherein consuming the gelatinous confection product includes chewing said product.

16. A method of minimizing the demineralization of teeth upon the consumption of a gummy confection comprising the steps of:
providing a gelatinous gummy confection product comprising carbamide; and
consuming the gelatinous confection product.

17. The method of claim 16, wherein consuming the gelatinous confection product includes chewing said product.

18. The method of claim 16, which includes consuming at least two pieces of confection product at a time.

19. The method of claim 16, which includes consuming the confection product after consuming foodstuffs containing acids.

20. The method of claim 16, which includes consuming the confection product after consuming foodstuffs containing sugar.
